(19) United States
(12) Patent Application Publication
(10) Pub. No.: US 2004/0121052 A1
(43) Pub. Date: Jun. 24, 2004

(54) Apparatus and method for tempering frozen foodstuffs

(76) Inventor: Eldon Roth, Dakota Dunes, SD (US)

Correspondence Address: SHAFFER & CULBERTSON, L.L.P., 1114 LOST CREEK BLVD., SUITE 420, AUSTIN, TX, 78746, US

(21) Appl. No.: 10/328,591

(22) Filed: Dec. 23, 2002

(51) Int. Cl. A23L 3/00

(52) U.S. Cl. 426/241

(57) ABSTRACT

A frozen foodstuff tempering method includes forming a number of frozen foodstuff pieces into one or more discrete streams of material and then heating the stream or streams of material to raise the temperature of the material to a suitable working temperature. The streams of frozen foodstuff pieces may be formed by driving the pieces through small internal cross-section tempering tubes. One or more relatively large masses of frozen foodstuff may be comminuted to produce the desired frozen foodstuff pieces which are formed into the discrete stream or streams. Heat is applied to the stream or streams of frozen foodstuff pieces either directly by infrared, microwave, or conventional heating. Where the streams of frozen foodstuff are formed through conduits, the foodstuff pieces may be heated indirectly by heating the conduit material.

### TECHNICAL FIELD OF THE INVENTION

This invention relates to food processing devices and methods. More particularly, the invention relates to an apparatus and method for tempering frozen foodstuffs to place the foodstuffs in condition for further processing.

### BACKGROUND OF THE INVENTION

Many foodstuffs are frozen to preserve the foodstuffs during long-term storage and distribution to users. Maintaining a foodstuff at a sufficiently low temperature well below the freezing point of the foodstuff arrests most natural decay processes. Thus, freezing a foodstuff and holding the foodstuff at a proper storage temperature allows the frozen foodstuff be stored for extended periods without degrading in quality. Freezing is particularly advantageous for highly perishable foodstuffs such as meat products for example.

Frozen foodstuffs that are to be used by an end manufacturer in making another product may be formed or compacted into relatively large frozen blocks. These large frozen blocks of material make efficient use of both storage and shipping space, and are convenient for packaging and handling.

In order to use a frozen foodstuff in producing other products, it is necessary to temper the foodstuff to a higher working temperature at which the foodstuff may be conveniently worked. For example, finely comminuted meat products such as uncooked ground beef may be frozen for shipping to an end product manufacturer. The end product manufacturer must then temper the frozen ground beef to a working temperature near or slightly above the freezing temperature prior to introducing the ground beef into the end product manufacturing process. This end product manufacturing process may, for example, mix the ground beef with spices and other ingredients and may include cooking the mixture or may include simply forming the ground beef into patties or other forms for cooking.

One way to temper a frozen foodstuff is to simply hold the frozen foodstuff at the desired working temperature for a sufficient period of time to allow the foodstuff to slowly equilibrate to the higher temperature. However, this tempering method may take a very long time, particularly where the frozen foodstuff is initially at the very low storage temperatures preferred for many frozen foodstuffs.

In order reduce the time required to temper a frozen foodstuff to a desired working temperature, some tempering processes actively heat the frozen foodstuff. For example, a frozen foodstuff may be subjected to microwave radiation to heat the material and bring the material to the desired working temperature. This active heating may significantly reduce the time required for tempering, however, it can also have a detrimental effect on the quality of the foodstuff. In particular, actively heating a large mass of frozen foodstuff invariable overheats portions of the material. This overheating may at least partially denature or cook the foodstuff, making the material unsuitable or less desirable for use in the particular end product manufacturing process.

### SUMMARY OF THE INVENTION

The present invention provides apparatus and methods for tempering frozen foodstuffs to a suitable working temperature relatively quickly and without degrading the quality of the foodstuff. A method according to the present invention includes forming a number of frozen foodstuff pieces, that is, more than one piece, into one or more discrete streams of material and then heating the stream or streams of material to raise the temperature of the material to a suitable working temperature. The method may further include comminuting one or more relatively large masses of frozen foodstuff to produce the desired frozen foodstuff pieces which are formed into the discrete stream or streams. By forming the frozen foodstuff pieces into one or more streams of relatively small cross-section, it is possible to raise the temperature of the foodstuff pieces quickly and evenly to the desired working temperature and avoid problems with overheating portions of the material.

In one form, an apparatus for tempering frozen foodstuffs according to the present invention includes a frozen foodstuff drive arrangement for driving a number of frozen foodstuff pieces through one or more tempering tubes. The device further includes a heating arrangement for heating the frozen foodstuff pieces as they are driven or displaced through the tempering tubes. A comminuting arrangement may be included in the device for forming the frozen foodstuff pieces from one or more larger masses of frozen foodstuff, or the apparatus according to the invention may simply receive the frozen foodstuff pieces from a separate device.

A frozen foodstuff comminuting arrangement according to the present invention may include a separate chopping or grinding device that produces the desired size of frozen foodstuff pieces. These frozen foodstuff pieces may then be delivered to the frozen foodstuff drive arrangement. The drive arrangement may include a pump or any other device suited for driving the frozen foodstuff pieces through the tempering tubes.

Rather than having separate, discrete comminuting and drive arrangements, these elements of the invention may be combined in a single device. In these forms of the invention, the device may receive large blocks or masses of frozen foodstuff, size the material in one or more steps to form the final desired frozen foodstuff pieces, and then drive the pieces through the tempering tubes. For example, a device embodying the principles of the invention may include an auger device having a breaking section suitable for breaking large masses of frozen foodstuff into intermediate frozen foodstuff pieces. The auger device may also include a drive section for driving the intermediate pieces against a grinder screen or plate where the intermediate pieces may be further comminuted with a suitable cutting element or blade for forming the final frozen foodstuff pieces. The force from the drive section of the auger device extrudes the frozen foodstuff pieces through the openings of the grinder screen and also drives the frozen foodstuff pieces through the tempering tubes.

These and other advantages and features of the invention will be apparent from the following description of the preferred embodiments, considered along with the accompanying drawings.

### BRIEF DESCRIPTION OF THE DRAWINGS

FIG. 1 is a diagrammatic representation of a frozen foodstuff tempering apparatus embodying the principles of the present invention.

FIG. 2 is a partial longitudinal section view of a foodstuff tempering apparatus embodying the principles of the invention.

FIG. 3 is a right end view of the apparatus shown in FIG. 2.

### DESCRIPTION OF PREFERRED EMBODIMENTS

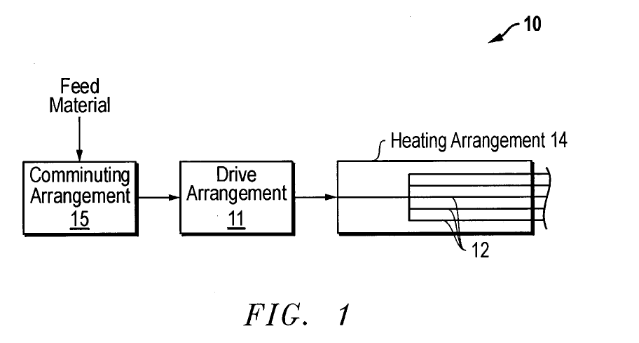

Referring to the high-level diagram of FIG. 1, a tempering apparatus 10 embodying the principles of the invention includes a drive arrangement or drive means 11, one or more tempering tubes 12, and a heating arrangement or heating means 14. Tempering apparatus 10 may also include a comminuting arrangement or comminuting means 15. Drive arrangement 11 receives frozen foodstuff pieces either from comminuting arrangement 15 or some other device and forces or drives frozen foodstuff pieces (not shown) through tempering tubes 12. Tempering tubes 12 serve to form the frozen foodstuff pieces into a number of streams of material which can be readily tempered to the desired working temperature by heating arrangement 14. Tempered foodstuff exiting tempering tubes 12 may be immediately be used in processes to produce a final food product.

FIG. 1 shows comminuting arrangement 15 and drive arrangement 11 as discrete devices or elements. The discrete comminuting arrangement 15 may include a bowl chopper, grinder, or any other device capable of comminuting a frozen foodstuff to produce the desired frozen foodstuff pieces. The comminution may be by fracturing or breaking the frozen foodstuff, cutting the frozen foodstuff, both fracturing and cutting, or by any other comminution process that serves to produce the frozen foodstuff pieces in the desired size range. A suitable discrete drive arrangement 11 may include a pump that receives the frozen foodstuff pieces and pumps the pieces into tempering tubes 12. A positive displacement pump, screw or auger-type pump, or any other pump suitable for pumping or driving frozen foodstuff pieces through tempering tubes 12 may be used in the drive arrangement 11. All of these different types of pumps are to be considered equivalents of each other.

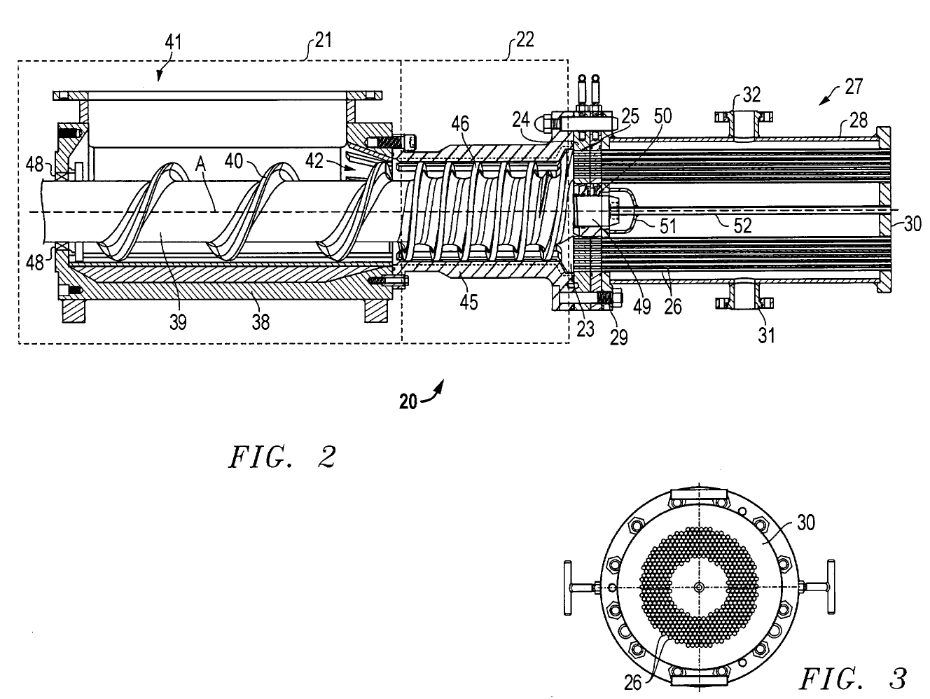

In addition to the discrete comminuting arrangement 15 and drive arrangement 11 indicated in FIG. 1, the invention encompasses an apparatus that incorporates the comminuting function and drive functions into a single device. Such a device will be described in detail below with reference to FIG. 2 and is to be considered an equivalent to the arrangement of discrete comminuting and drive arrangements, 14 and 15. Also, it will be appreciated that an apparatus embodying the principles of the invention may not include comminuting arrangement 15. In these forms of the invention, drive arrangement 11 receives the properly sized frozen foodstuff pieces, which may have been formed in an entirely separate process and at remote location, and directs the frozen foodstuff pieces through the tempering tubes to be heated to the desired working temperature.

Heating arrangement 14 may include any suitable device for heating the frozen foodstuff pieces as they pass through tempering tubes 12. For example, a suitable heating arrangement may include a heat exchange enclosure surrounding at least a portion of the tempering tubes 12 in position to hold a suitable heat exchange fluid in a heat exchange relationship with the tempering tubes. In this heating arrangement, the frozen foodstuff pieces within tempering tubes 12 are heated indirectly through the tube material. Another indirect heating arrangement encompassed within the scope of the present invention may include a device for heating the tube material by electrical induction or a similar process. Alternatively to heating the frozen foodstuff pieces indirectly by heat transferred through tempering tubes 12, a heating arrangement within the scope of the present invention may heat the frozen foodstuff pieces directly by applying microwave radiation or other suitable electromagnetic radiation to the frozen foodstuff pieces as the pieces are arranged in the one or more streams. Heating devices adapted to heat the foodstuff pieces directly by infrared, microwave, or conventional heating, and heating devices adapted to heat the foodstuff indirectly by heat transfer through an intermediate containment material such as the material forming a tube are to be considered equivalents of each other.

The frozen foodstuff pieces are preferably fairly small in cross-section to facilitate rapid heating to the desired working temperature as the pieces pass through tempering tubes 12. Although it is possible to use sizes outside the preferred size range within the scope of the present invention, the preferred cross-sectional size of the frozen foodstuff pieces is one and one-quarter (1.25) inches or less, and more preferably not greater than around one-quarter (0.25) inch. Tempering tubes 12 will preferably include an internal diameter or maximum dimension similar to the maximum cross-sectional size of the frozen foodstuff pieces. This correspondence between the size of frozen foodstuff pieces and the internal dimension of the tempering tubes helps ensure rapid and even tempering in the foodstuff. Due to the small cross-section of tempering tubes 12, preferred forms of the invention will include a number of tempering tubes 12, that is, more than one tube, to increase the throughput capacity of the apparatus.

FIG. 2 shows a foodstuff tempering apparatus 20 that incorporates both the comminuting and drive functions described above with referenced in FIG. 1 into a single device. Apparatus 20 includes a breaking section indicated by dashed box 21 and a grinder that includes a drive section indicated by dashed box 22, a grinder blade 23, and a grinder plate 24. Grinder plate 24 includes a number of plate openings 25 with one or more, and preferably each opening, aligned with a respective tempering tube 26. Plate openings 25 each extend from an inlet end facing auger 39 to an outlet end facing the respective tempering tube 26.

The form of the invention shown in FIG. 2 includes a heating arrangement that includes a heat exchange enclosure 27 made up of a shell 28, an inlet flange 29, and an outlet flange 30. Tempering tubes 26 extend between inlet flange 29 and outlet flange 30 with shell 28 connected to the flanges and surrounding the tempering tubes. This structure of tubes 26 and enclosure 27 forms a heat exchanger facilitating the exchange of heat between the material passing through the tempering tubes and a heat exchange fluid within the enclosure. Shell 28, inlet flange 29, outlet flange 30, and tempering tubes 26 may be formed as unit with the tempering tubes welded or otherwise rigidly connected to the flanges 29 and 30, and with the flanges welded or otherwise rigidly connected to the shell. A heat exchange fluid can be circulated through the area defined between shell 28 and tempering tubes 26 through a heat exchange fluid inlet 31 and a heat exchange fluid outlet 32. It will be appreciated that a heat exchange fluid supply (not shown) will be connected to inlet 31 and outlet 32 for circulating a suitable heat exchange fluid such as water through the area defined between shell 28 and tempering tubes 26.

The breaking section 21 of apparatus 20 includes a housing 38 through which an auger 39 extends along an auger axis A. Auger 39 includes a breaking flight 40 that extends along the length of breaking section 21. A feed opening 41 is included in housing 38 through which relatively large pieces of frozen foodstuffs may be introduced into the housing to be broken by the action of breaking flight 40. As auger 39 is rotated properly in an operating direction about auger axis A, the top edge of breaking flight 40 contacts the frozen foodstuff extending into feed opening 41 and forces the material to the right in the figure to break off portions of the frozen foodstuff. These intermediate pieces of frozen foodstuff may break up more as they are forced further to the right in the drawing through the narrowing portion 42 of housing 38 and into the grinder drive section 22.

Referring still to FIG. 2 the grinder includes a grinder housing 45 aligned with the breaking section housing 38. Auger 39 extends further along its axis A through grinder housing 45, and includes a drive flight 46 preferably having a smaller spacing than breaking flight 40. In this form of the invention, intermediate sized pieces of frozen foodstuff are pressed or forced against grinder plate 24 by drive flight 46 as auger 39 is properly rotated on axis A. At the right end of drive flight 46, grinder blades 23 or cutting elements extend transverse to auger axis A in position to pass over grinder plate openings 25 as auger 39 rotates. This passage of blades 23 over grinder plate openings 25 provides a cutting action that further comminutes the intermediate sized pieces of frozen foodstuff to produce the final small frozen foodstuff pieces. The pressure provided by the drive flight 46 as auger 39 rotates properly on axis A drives or extrudes the small frozen foodstuff pieces through grinder plate openings 25 and ultimately through tempering tubes 26.

Alternatively to blades 23, other preferred forms of the invention include a pressure flight at the end of the auger. The pressure flight serves to wipe the surface of grinder plate 24 and press frozen foodstuff pieces through plate openings 25 to create small strands.

Auger 39 is supported at its left end in the drawing by bearing structure 48. Although not shown in FIG. 2, it will be appreciated that a suitable auger drive arrangement will be coupled to 39 auger at the left end of the device as shown in the figure. The right end of auger 39 includes a spindle 49 that extends through a spindle opening 50 in grinder plate 24. As is well know in the art of plate-types grinders, one or more passages (not shown in the figure) are associated with spindle 49 for passing material that is not pressed into the grinder plate openings 25. Material exiting housing 45 through these openings collects in separation housing 51 and is eventually displaced through a separation tube 52 extending generally along the auger axis A through heat exchange enclosure 27.

Apparatus 20 shown in FIG. 2 includes numerous details of construction that are not necessary to the present invention. For example, breaking housing 38 and grinder housing 45 are shown as separate structures connected together by flanges. However, any suitable connections may be used instead of the illustrated flanges, or the two housing sections could be integrally formed. Similarly, the flange connections illustrated for the heat exchange inlet 31 and outlet 32 could be replaced by and any suitable connections such as threaded connections for example, or welded lines. Those skilled in the art of food processing will appreciated that the various components of apparatus 20 may be constructed from may different types of material including food processing grade stainless steels. The invention as defined in the following claims is not limited to any particular types of materials or construction details.

FIGS. 2 and 3 show a large number of tempering tubes 26, with each tube aligned with a respective grinder plate opening 25. This one-to-one correspondence between grinder plate openings 25 and tempering tubes 26 is helpful to provide the desired small cross-section streams of frozen foodstuff pieces. However, one-to-one correspondence is not necessary to the present invention, nor are multiple streams of frozen foodstuffs. A tempering apparatus within the scope of the present invention may include only a single tempering tube, or a number of tempering tubes. Each tempering tube may be connected to receive material from a single grinder plate or extrusion opening, or number of separate grinder plate or extrusion openings.

Tempering tubes 26 may be closely spaced through the area defined by heat exchange enclosure 27, however, there should be sufficient space around the individual tempering tubes to ensure that heat exchange fluid may flow freely over at least a portion of all of the tempering tubes. Other forms of the apparatus according to the invention may include tempering tubes that provide a radially outward offset from auger axis A, rather than the illustrated linear tubes. This offset allows a portion of the tempering tubes to be more widely spaced apart to facilitate better flow of heat exchange fluid around the tubes. Other forms of the invention may include grinder plate openings that extend at various angles through the grinder plate so that the outlet grinder plate openings are spaced further apart than the inlet grinder plate openings. This arrangement also allows for further spacing between tempering tubes within a heat exchange enclosure.

Apparatus 20 shown in FIG. 2 is particularly suited for tempering frozen foodstuffs that have been formed into large blocks or masses of frozen material. The breaking section of the device breaks the large masses of frozen foodstuff into intermediate sized pieces and the grinder portion of the apparatus provides final sizing as the foodstuff is displaced through the grinder plate openings 25 and through the relatively narrow tempering tubes 26. However, apparatus 20 may also receive relatively small masses or chips of frozen foodstuff rather than large blocks of material. A method for tempering frozen foodstuff according to the present invention includes forming at least one stream of frozen foodstuff pieces and preferably a number of streams of frozen foodstuff pieces. The streams may be formed using conduits or tubes such as the tempering tubes 12 shown in FIGS. 1 and 26 shown in FIGS. 2 and 3.

Regardless of how the stream or streams of frozen foodstuff pieces are formed, the method also includes heating the streams of frozen foodstuff pieces. The manner in which this heating may be accomplished will depend in part upon how the streams of foodstuff pieces are formed. For example, if the frozen foodstuff pieces are formed through tubes, the tube material may be heated by heat transfer with a heat exchange fluid. In the tubes are made of suitable metals, the tubes may be heated through electrical induction heating for example. Glass or ceramic tempering tubes may allow direct heating using infrared or microwave radiation. Regardless of how the heating is accomplished, the relatively small cross-section streams of frozen foodstuff pieces allow the material to be heated evenly and without overheating a portion of the material while the remainder of the material remains below the desired working temperature.

A tempering method according to the invention may also include the step of comminuting a large mass of frozen foodstuff into smaller pieces which may then be driven through a stream forming arrangement such as a number of tempering tubes. This comminution may include breaking one or more large masses of frozen foodstuff into intermediate sized pieces of frozen foodstuff and then cutting the intermediate pieces of material to form a final sized material that may be forced through small cross-section tempering tubes.

The above described preferred embodiments are intended to illustrate the principles of the invention, but not to limit the scope of the invention. Various other embodiments and modifications to these preferred embodiments may be made by those skilled in the art without departing from the scope of the following claims.

1. A foodstuff tempering device including:
(a) a foodstuff pump having a pump outlet;
(b) a tempering tube connected to receive material pumped through the pump outlet; and
(c) a heating device positioned to heat material within at least a portion of the tempering tube.

2. The foodstuff tempering device of claim 1 wherein the heating device includes a heat exchange enclosure defining a heat exchange fluid containment area around the tempering tube.

3. The foodstuff tempering device of claim 1 wherein the heating device includes an electromagnetic radiation emitting device.

4. The foodstuff tempering device of claim 1 wherein the foodstuff pump includes a number of extrusion openings and further including a corresponding number of tempering tubes, each tempering tube connected to a respective one of the extrusion openings to receive material extruded through the respective extrusion opening.

5. The foodstuff tempering device of claim 4 wherein the foodstuff pump includes an auger-type pump.

6. The foodstuff tempering device of claim 5 further including a blade and a blade driving arrangement for driving the blade across the extrusion openings.

7. The foodstuff tempering device of claim 6 wherein the auger-type pump includes:
(a) a foodstuff mass receiving opening; and
(b) an auger having a breaking auger flight that passes across the foodstuff mass receiving opening as the auger is rotated in an operating direction about an auger axis.

8. A foodstuff tempering device including:
(a) a grinder having a grinding plate with a number of grinding plate openings extending there through from a respective inlet end to a respective outlet end;
(b) a number of tempering tubes, each tempering tube being aligned with a respective one of the grinder plate openings to receive material exiting the outlet end of the respective grinder plate opening; and
(c) a heat exchange fluid enclosure surrounding at least a portion of at least one of the tempering tubes.

9. The foodstuff tempering device of claim 8 wherein the grinder includes an auger mounted to be driven in an operating direction to drive material through the grinder plate.

10. The foodstuff tempering device of claim 9 wherein the auger includes a breaking auger flight that passes across a foodstuff mass receiving opening associated with the grinder as the auger is driven in the operating direction.

11. An apparatus for tempering frozen foodstuffs, the device including:
(a) a frozen foodstuff drive arrangement for driving frozen foodstuff pieces through a tempering tube; and
(b) a heating arrangement for heating the frozen foodstuff pieces as they are driven through at least a portion of the tempering tube.

12. The apparatus of claim 11 further including a frozen foodstuff comminuting arrangement for forming the frozen foodstuff pieces from one or more masses of frozen foodstuff.

13. The apparatus of claim 12 wherein:
(a) the frozen foodstuff comminuting arrangement comprises a foodstuff sizing device; and
(b) the frozen foodstuff drive arrangement comprises a pump connect between the foodstuff sizing device and the foodstuff tempering tube.

14. The apparatus of claim 11 wherein the frozen foodstuff drive arrangement incorporates a comminuting arrangement for forming the frozen foodstuff pieces from one or more masses of frozen foodstuff.

15. The apparatus of claim 11 wherein the heating arrangement includes a heat exchange enclosure defining a heat exchange fluid area surrounding at least a portion of the tempering tube.

16. The apparatus of claim 11 wherein the heating arrangement includes an infrared or microwave radiation emitting device.

17. The apparatus of claim 11 wherein the heating arrangement includes an induction heating device inductively coupled to the tempering tube.

18. A method for tempering a frozen foodstuff, the method including the steps of:
(a) forming a stream of frozen foodstuff pieces in a tempering tube; and
(b) heating the stream of frozen foodstuff pieces in the tempering tube.

19. The method of claim 18 further including the step of comminuting a mass of frozen foodstuff to form the frozen foodstuff pieces.

20. The method of claim 19 wherein the step of comminuting includes breaking up the mass of frozen foodstuff to form intermediate sized pieces of frozen foodstuff and then cutting the frozen foodstuff to produce the frozen foodstuff pieces.

21. The method of claim 18 wherein the step of heating the stream of frozen foodstuff pieces includes placing a heat exchange fluid in a heat exchange relationship with at least a portion of the tempering tube.

22. The method of claim 18 wherein the step of heating the stream of frozen foodstuff pieces includes applying electromagnetic radiation to the foodstuff within at least a portion of the tempering tube.
